(19) United States
(12) Patent Application Publication
(10) Pub. No.: US 2024/0317468 A1
(43) Pub. Date: Sep. 26, 2024

(54) REVERSIBLE LID

(71) Applicant: Doskocil Manufacturing Company, Inc., Arlington, TX (US)

(72) Inventors: Josiah WILHELM, Arlington, TX (US); Karl BOEHRINGER, Arlington, TX (US); Ron BAGLEY, Arlington, TX (US)

(21) Appl. No.: 18/124,356

(22) Filed: Mar. 21, 2023

(51) Int. Cl. B65D 43/02; B65D 25/32; B65D 25/38; B65D 51/24

(52) U.S. Cl. CPC B65D 43/0218; B65D 25/32; B65D 25/38; B65D 51/24; B65D 2543/00092; B65D 2543/0025; B65D 2543/00296; B65D 2543/00351; B65D 2543/005; B65D 2543/00537; B65D 2543/00555

(57) ABSTRACT

A reversible lid, the reversible lid includes a covering portion and a circumferential portion. The circumferential portion has a first part, a second part and a transverse part. The first part has a first end and a second end and extends generally parallel from the periphery of the covering portion at the first end. The transverse part extends radially outwardly transverse from the second end of the first part, and the second part extends in a same direction as the first part and is connected to the transverse part. The first part, the second part and traverse part are configured such that in a first orientation the lid covers the container with a first side of the transverse part abutting a rim of the container and in a second orientation covers the container with the second side of the transverse part abutting the rim of the container.

### BACKGROUND

### Technical Field

The present disclosure generally relates to a reversible lid for a container.

### Background Information

Many pet owners play with their pets using various toys and treats. Often times a pet owner may play with the pet away from home and carrying multiple toys and feeding the pet are desired.

### SUMMARY

It has been found that an improved manner of carrying toys and food, feeding and providing water for a pet is desired. In view of the state of the known technology, a first aspect of the present disclosure is to provide a reversible lid, the reversible lid comprising a covering portion configured to cover an opening in a container, the covering portion being circular and having a periphery, and a circumferential portion having a first part, a second part and a transverse part, the first part having a first end and a second end, and extending generally parallel from the periphery of the covering portion at the first end, the transverse part extending radially outwardly transverse from the second end of the first part, and the second part extending in a same direction as the first part and connected to the transverse part, the first part, the second part and traverse part configured such that in a first orientation the lid is configured to cover the container with a first side of the transverse part abutting a rim of the container and in a second orientation the lid is configured to cover the container with the second side of the transverse part abutting the rim of the container.

A second aspect of the present disclosure is to provide a container system, comprising a container having an opening and a rim, and a lid including a covering portion and a circumferential portion, the covering the opening in the container, being circular and having a periphery, and the circumferential portion having a first part, a second part and a transverse part, the first part having a first end and a second end, and extending generally parallel from the periphery of the covering portion at the first end, the transverse part extending radially outwardly transverse from the second end of the first part, and the second part extending in a same direction as the first part and connected to the transverse part, the first part, the second part and traverse part configured such that when disposed on the container in a first orientation, the lid covers the container with a first side of the transverse part abutting the rim of the container and in a second orientation the lid covers the container with the second side of the transverse part abutting the rim of the container.

A third aspect of the present disclosure is to provide a reversible lid according to a previous aspect, wherein in the first orientation, an inner surface of the second part at a second end of the second part is configured to be adjacent an outer surface of the container.

A fourth aspect of the present disclosure is to provide a reversible lid according to a previous aspect, wherein in the second orientation, an inner surface of the second part at a first end of the second part is configured to be adjacent the outer surface of the container.

A fifth aspect of the present disclosure is to provide a reversible lid according to a previous aspect, wherein at a first end of the second part is configured to be adjacent the outer surface of the container.

A sixth aspect of the present disclosure is to provide a reversible lid according to a previous aspect, wherein the second part includes a first circumferential area and a second circumferential area, in the first circumferential area, a distance from the first end of the second part to the transverse part is greater than a distance from the second end of the transverse part to the traverse part.

A seventh aspect of the present disclosure is to provide a reversible lid according to a previous aspect, wherein in the second circumferential area, the distance from the first end of the second part to the transverse part is less than the distance from the second end of the transverse part to the traverse part.

An eighth aspect of the present disclosure is to provide a reversible lid according to a previous aspect, wherein in the first orientation, the covering portion is configured to be longitudinally above the rim of the container.

A ninth aspect of the present disclosure is to provide a reversible lid according to a previous aspect, wherein in the second orientation, the covering portion is configured to be longitudinally below the rim of the container.

A tenth aspect of the present disclosure is to provide a reversible lid according to a previous aspect, wherein in the second orientation, the lid is configured to form a recess.

This embodiments of the present disclosure provide a carrying system and lid that improves the traveling and/or storing experience for pet owners. As can be understood, the lid is reversible and thus can be positioned on the container in two different orientations or positions. In one position, the lid enables an increased storage space within the container, enabling storage and carrying of larger products. In a second orientation or position, the lid provides for a recess in the top of the container. This recess can be used to hold objects, feed an animal or provide water for an animal, or provide an area for numerous other purposes.

### BRIEF DESCRIPTION OF THE DRAWINGS

Referring now to the attached drawings which form a part of this original disclosure:

FIG. 1 is a top perspective view of the container with the lid in a first orientation;

FIG. 2 is a bottom perspective view of the container with the lid in a first orientation;

FIG. 3 is a top perspective view of the container with the lid in a second orientation;

FIG. 4 is a side view of the container with the lid in the first orientation;

FIG. 5 is a front view of the container with the lid in the first orientation rotated 90 degrees;

FIG. 6 is a side view of the container with the lid in the second orientation;

FIG. 7 is a front view of the container with the lid in the second orientation rotated 90 degrees;

FIG. 8 is a cross sectional view of the container with the lid in the first orientation along lines 8-8 in FIG. 4;

FIG. 9 is a cross sectional view of the container with the lid in the first orientation along lines 9-9 in FIG. 5;

FIG. 10 is a cross sectional view of the container with the lid in the second orientation along lines 10-10 in FIG. 7;

FIG. 11 is a cross sectional view of the container with the lid in the second orientation along lines 11-11 in FIG. 6;

FIG. 12 is a top perspective view of the lid of FIG. 1;

FIG. 13 is a side view of the lid of FIG. 1;

FIG. 14 is another side view of the lid of FIG. 1;

FIG. 15 is a top plan view of the lid of FIG. 1; and

FIG. 16 is a bottom view of the lid of FIG. 1; and

FIG. 17 is a cross sectional view of the container with the lid in the second orientation along lines 17-17 in FIG. 14; and

FIG. 18 is a cross sectional view of the container with the lid in the second orientation along lines 18-18 in FIG. 13.

### DETAILED DESCRIPTION

Selected embodiments will now be explained with reference to the drawings. It will be apparent to those skilled in the art from this disclosure that the following descriptions of the embodiments are provided for illustration only and not for the purpose of limiting the invention as defined by the appended claims and their equivalents.

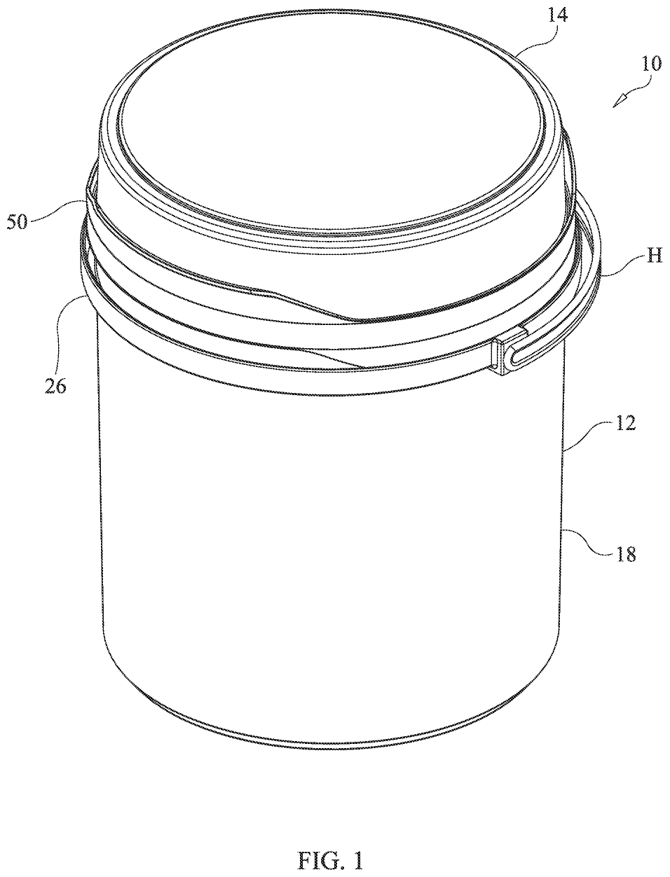

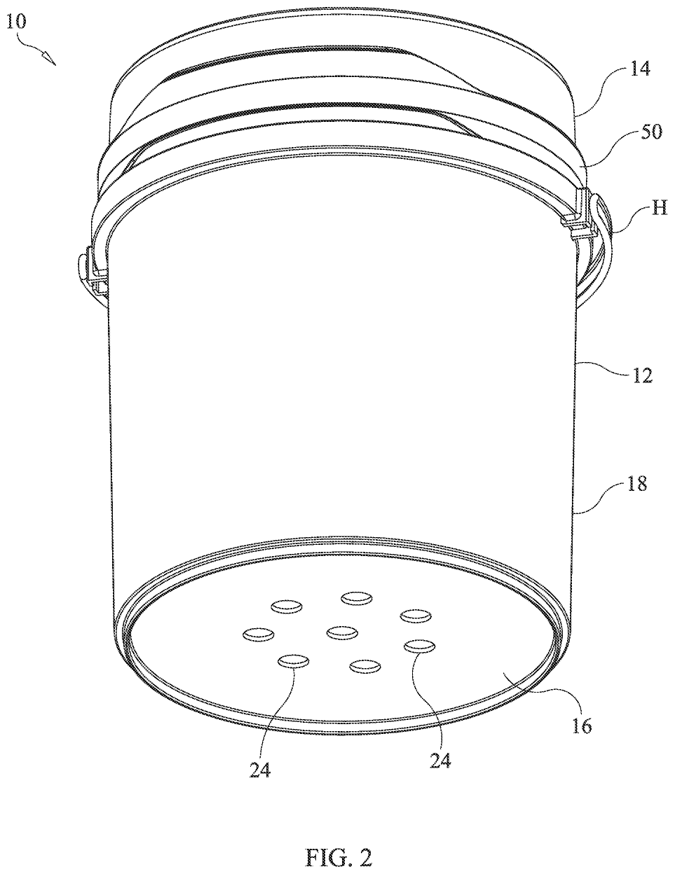

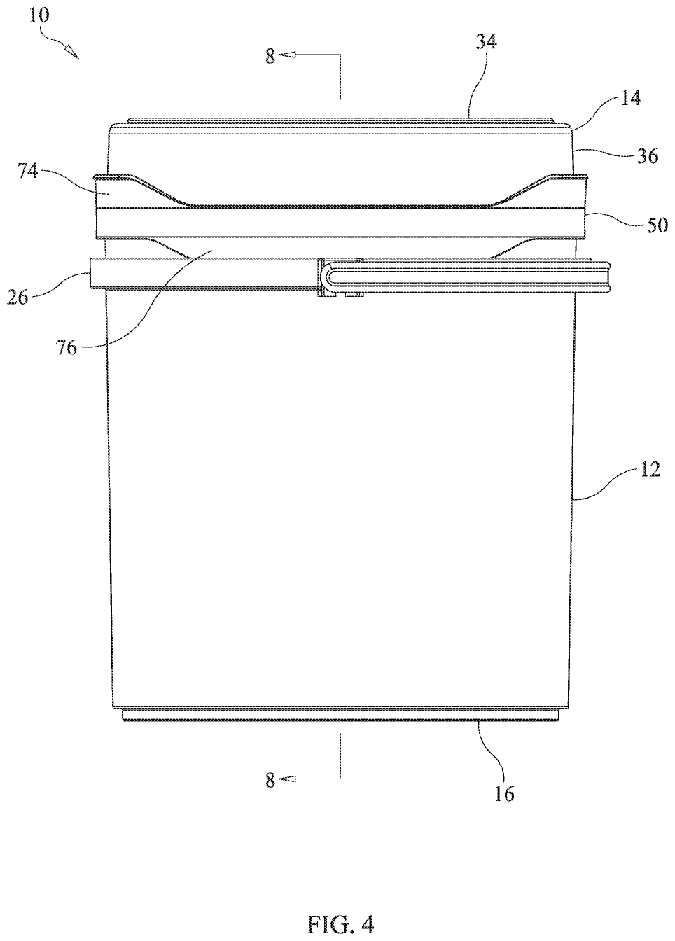

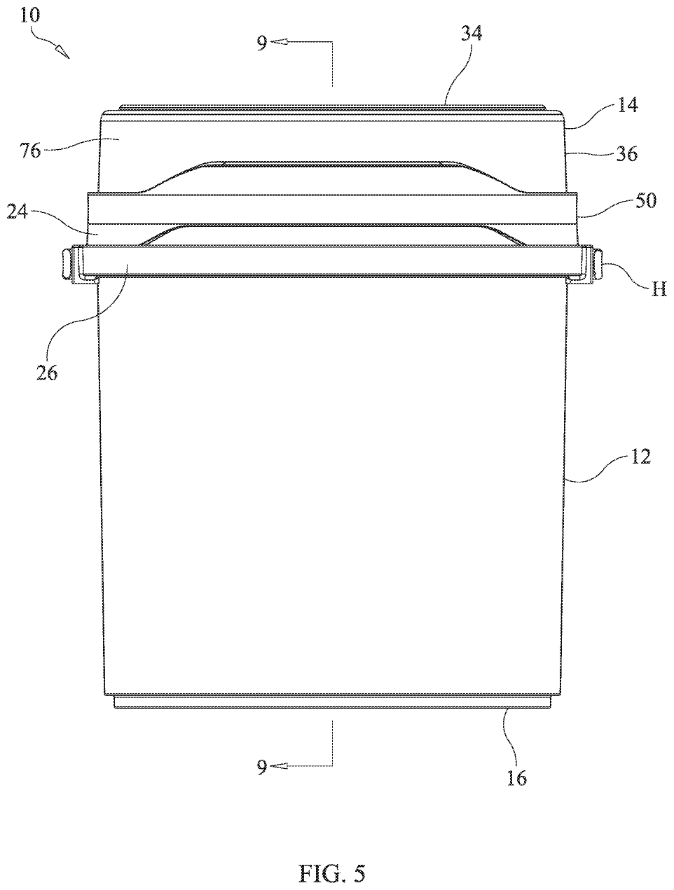

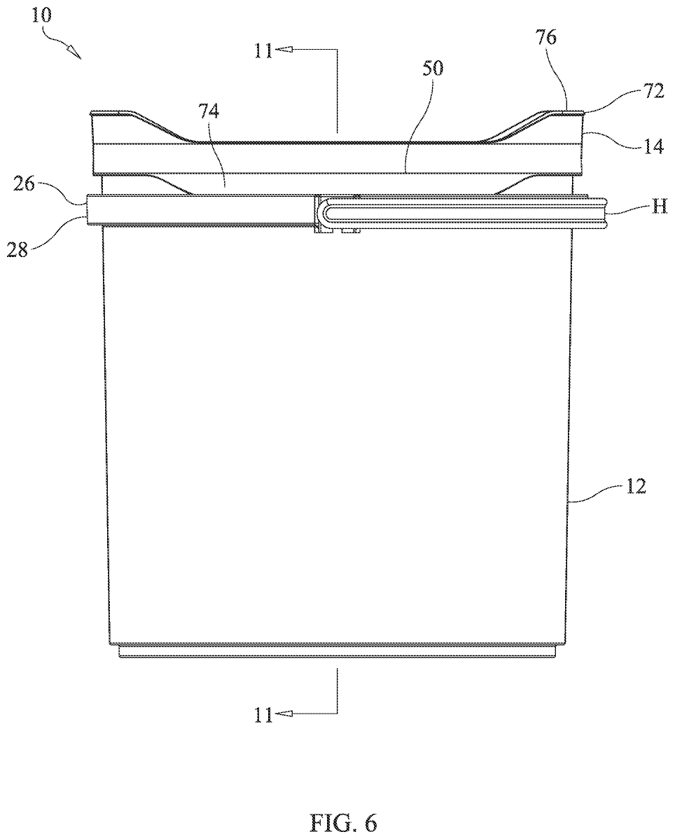

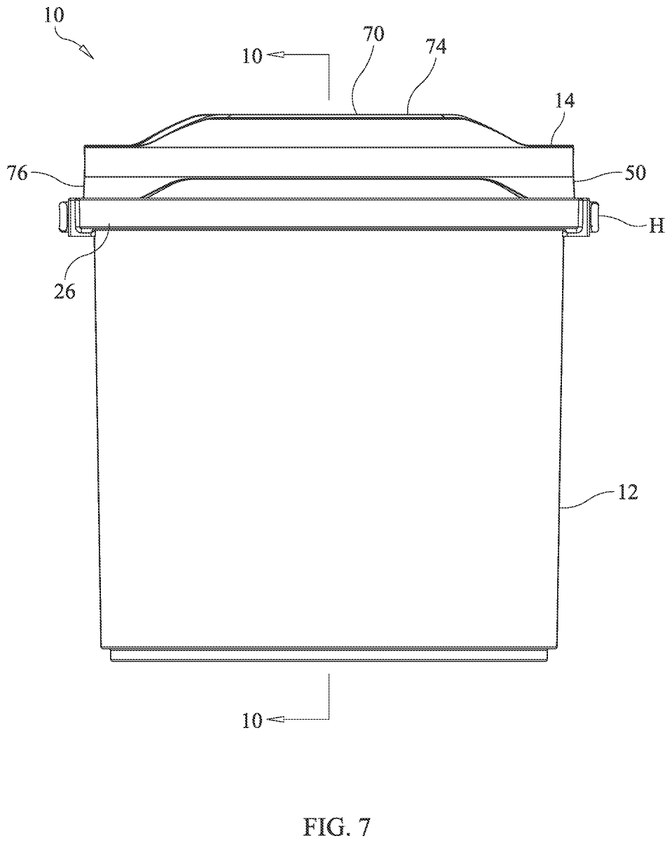

Referring initially to FIGS. 1 and 2, a container system 10 including a container 10 and a reversible lid 14 is illustrated. As can be understood, the container system 10 is configured to carry items within the interior portion I thereof. For example, the container 12 can carry pet toys, food for the pet or for another person or animal, water, and any other suitable item. The lid 14 is configured to fit onto the container 12 in a first configuration, as illustrated in FIGS. 1, 2, 4 and 5 and a second configuration, as illustrated in FIGS. 2, 6 and 7.

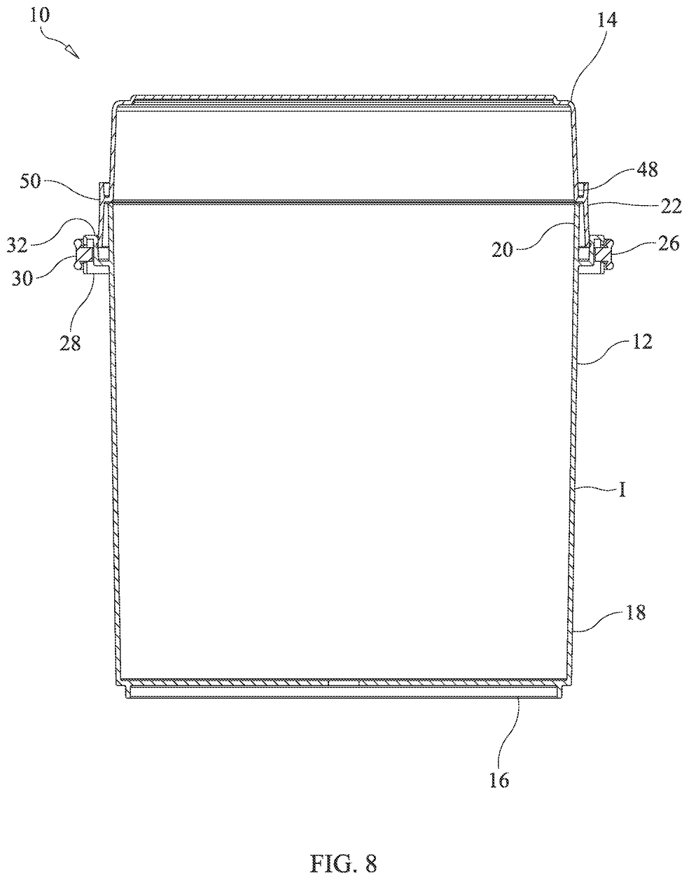

The container 12 can be any suitable container 12. In one embodiment, the container 12 is a generally cylindrical container formed from plastic or other suitable material. The container 12 can have a bottom 16 and a cylindrical side 18. The side 18 can extend from the periphery of the bottom 16 in a generally perpendicular direction or other suitable angle. As illustrated in FIGS. 8-11, the side 18 defines an opening 20 at the top 22 thereof. In one embodiment the bottom 16 of the container 12 includes openings 24. The openings 20 enable liquids or other material to pass from the interior portion I of the container 12 through the bottom 16 and out of the container 12. Such a configuration enables any liquids (e.g., slobber) from the toys to easily pass out of the container 12 rather than be trapped therein. Moreover, the openings 20 enable easy cleaning of the interior portion I of the container 12.

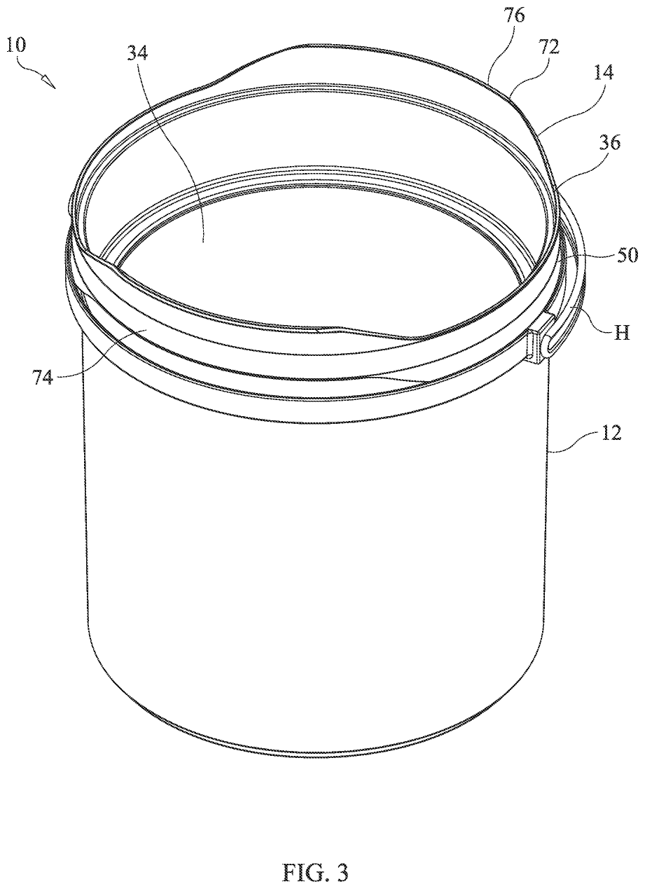

As shown in FIGS. 8-11, adjacent to the opening 20 in the container 12, the container 12 has a circumferential locking flange 26. The locking flange 26 includes a first part 28 that extends radially outwardly and a second part 30 that extends from the first part 28 in a longitudinal direction of the container 12. The second part 30 can have a lip or protrusion 32 for locking with the lid 14. Additionally, as shown in FIGS. 1-3 a hinged handle H can be attached to the outer surface of the second part 30 of the locking flange 26.

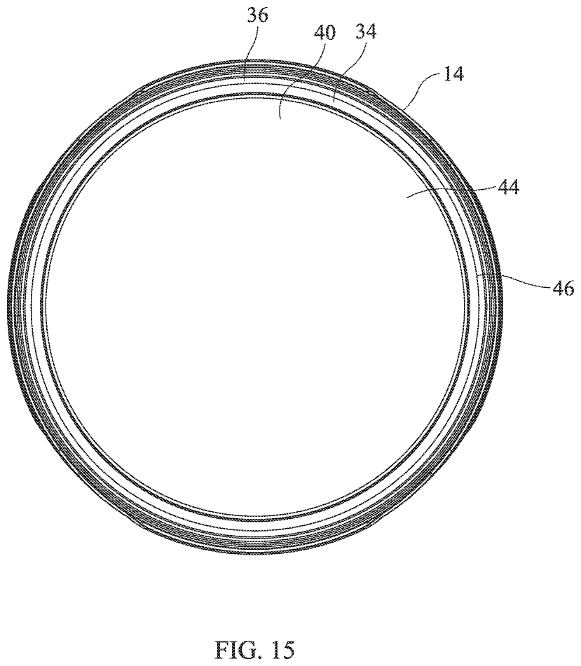

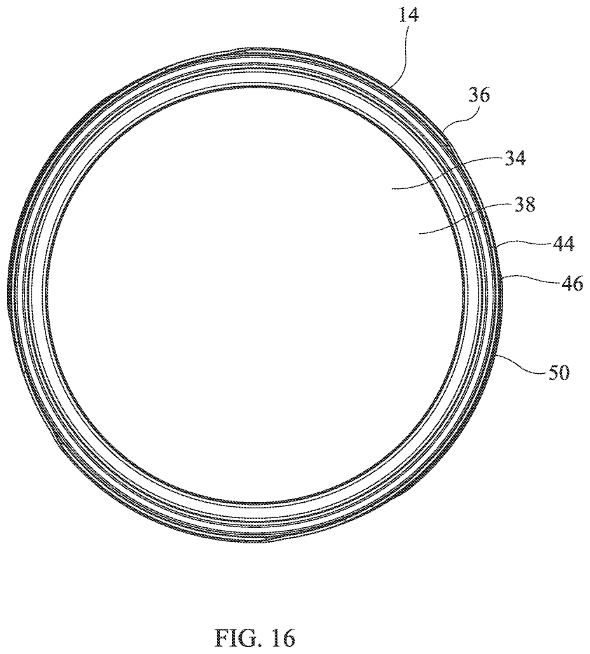

As shown in FIGS. 12-18, the reversible lid 14 is generally made of plastic and includes a covering portion 34 and a circumferential portion 36. The covering portion 34 and the circumferential portion 36 can be a unitary one piece member that is formed in a mold. However, the covering portion 34 and the circumferential portion 36 can be formed in any suitable manner.

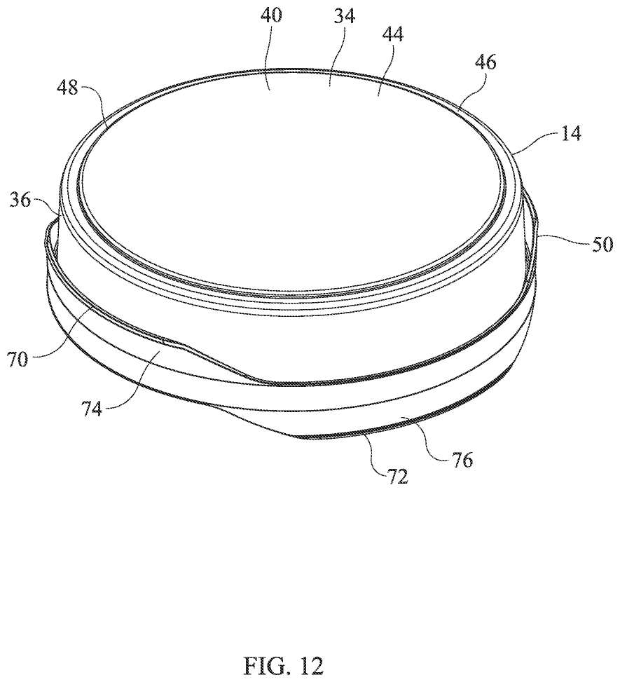

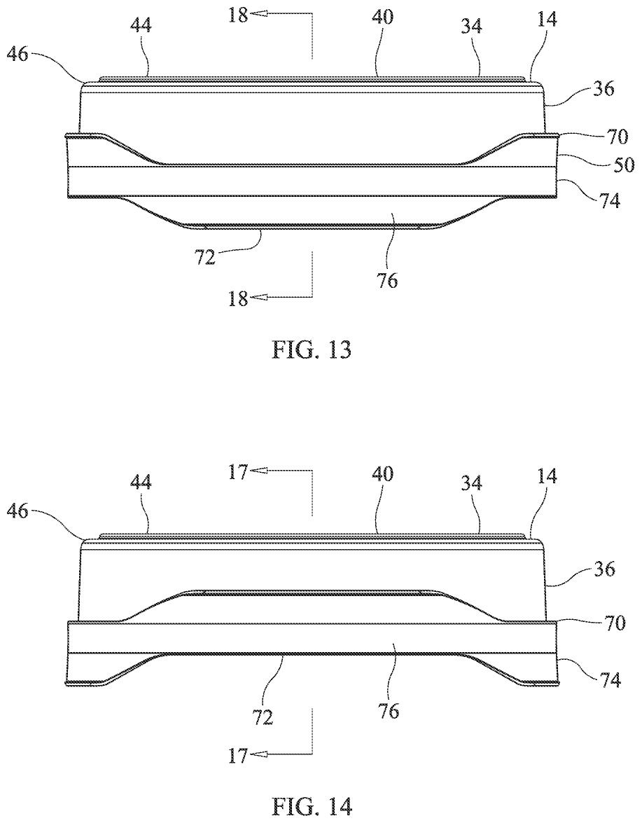

The covering portion 34 can be considered a top portion or a closing portion that generally covers the opening 22 to the container 12. The covering portion 34 is generally circular and includes a first inner surface 38 and a second outer surface 40. The covering portion 34 can include an inner portion 44 and an outer portion 46 disposed on different planes such that the inner portion 44 is offset from the outer portion 46. See for example, FIGS. 13, 14, 17 and 18. In other words, when disposed in the first orientation, the covering portion 34 has a protrusion extending upwardly and away from the container 12. When disposed in the second orientation, the covering portion 34 has a recess extending downwardly and toward the bottom 16 of the container 12.

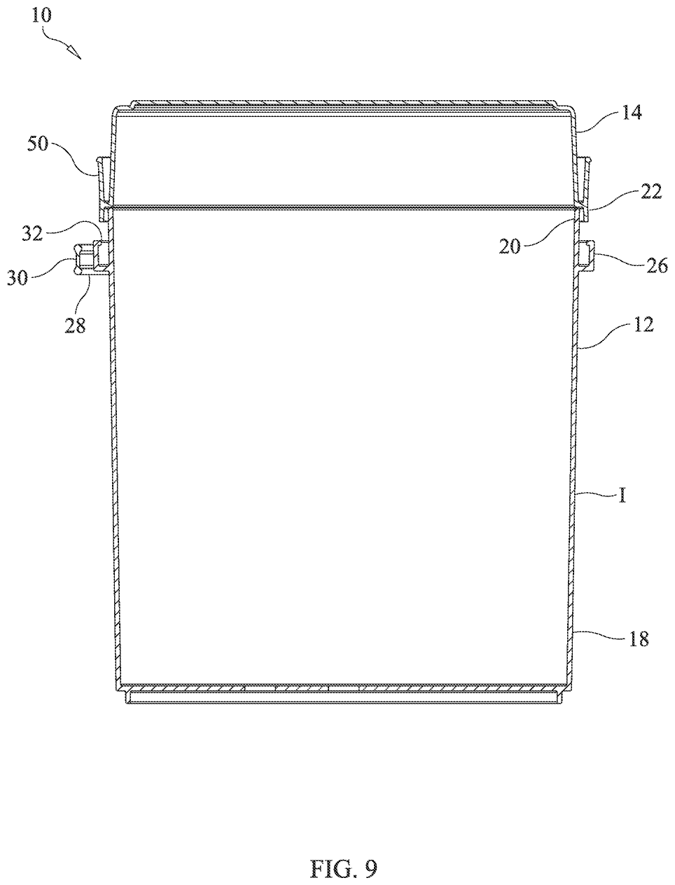

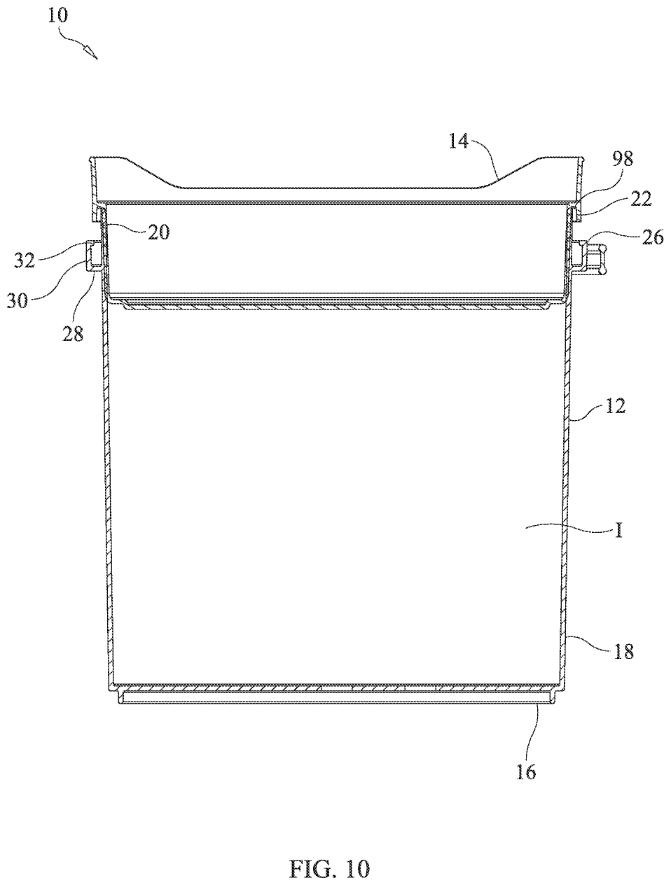

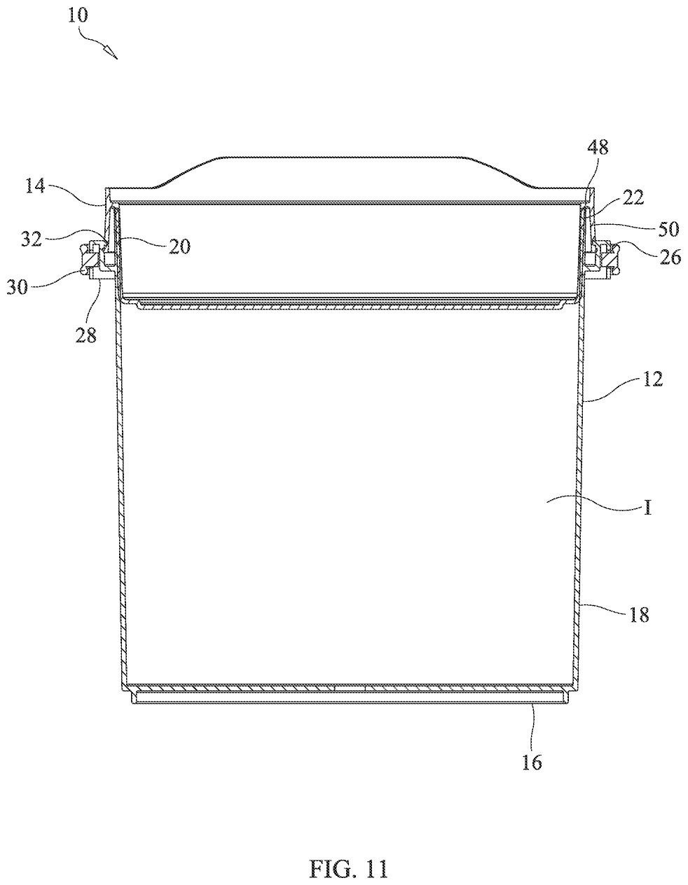

In the first orientation, as shown in FIGS. 8 and 9, the covering portion 34 is configured to be longitudinally above the rim 48 at the top 22 of the container 12. In this orientation, the interior portion I of the container 12 can be increased. Thus, the lid 14 enables an increased storage space within the container 12, enabling storage and carrying of larger products. In the second orientation, as shown in FIGS. 10 and 11, the covering portion 34 is configured to be longitudinally below the rim 48 of the container 12. In the second orientation or position, the lid 14 provides for a recess in the top of the container 12. This recess can be used to hold objects, feed an animal or provide water for an animal, or provide an area for numerous other purposes.

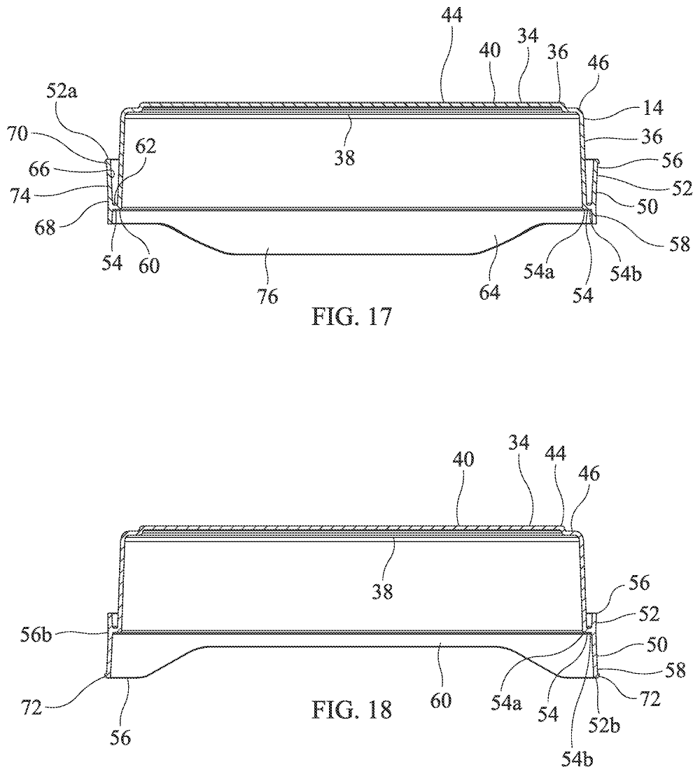

As illustrated in 1-3, the circumferential portion 36 has locking element 50 that extends circumferentially around the circumferential portion 36. As illustrated in FIGS. 17 and 18, the locking element 50 includes a circumferential part 52 and a traverse part 54. The circumferential part 52 includes a first part 56 and a second part 58 and a transverse part 54. The transverse part 54 extends radially outwardly transverse from the circumferential portion 36 at a first end 54a. The first part 56 and the second part 58 extend from the second end 54b of the transverse part 54. The second part 58 extends in the same direction as the first part 56 and the first part 56 is connected to the second part 58 at the transverse part.

In one embodiment, the circumferential part 52 has a first end 52a and a second end 52b and extends generally parallel to the outer surface of the circumferential portion 36. The first part 56, the second part 58 and traverse part 56 are configured such that in a first orientation the lid 14 covers the container 12 with a first side 60 of the transverse part 54 abutting the rim 48 of the container 12 and in a second orientation covers the container 12 with the second side 62 of the transverse part 54 abutting the rim 48 of the container 12.

In the first orientation, an inner surface 64 of the second part 58 of the circumferential part 52 is configured to be adjacent an outer surface of the container 12. In the second orientation, an inner surface 66 of the first part 56 of the circumferential part 52 is configured to be adjacent the outer surface of the container 12.

The outer surface 68 of the circumferential part 52 at each of the first end 52a and the second end 52b can have a rib or circumferential protrusion 70, 72. The ribs 70, 72 at the first and second end 52a, 52b, respectively enable the circumferential part 52 to engage with lip or protrusion 32 on the inner surface of the locking flange 26 to keep the lid 14 in place in both the first orientation and the second orientation.

The circumferential part 52 also includes a first circumferential area 74 and a second circumferential area 76, in the first circumferential area, a distance from the first end 52a of the circumferential part 52 to the transverse part 54 is greater than a distance from the second end 52b of the circumferential part 52 to the traverse part 54. Thus, as illustrated the second part has an undulation or wave as the circumferential part 52 circumscribes the lid 14. This undulation enables approximately half of the circumferential part 52 to extend at a sufficient length along the outer surface of the container 12 in both the first and second orientations to enable the locking element 52 to engage the locking flange 26 while reducing the amount of material required. Moreover, this configuration increases the aesthetic value and design characteristics of the lid 14.

Thus, as can be understood, in the second circumferential area 76, the distance from the first end 52a of the circumferential part 52 to the transverse part 54 is less than the distance from the second end 52b of the circumferential part 52 to the traverse part 54.

In operation, a user can put pet toys, treats or any other suitable products or things in the interior part of the container 12. The lid 14 can then be attached to the container 12 in the first orientation. In this orientation, the inner surface of the circumferential part 52 on the circumferential portion 36 is disposed adjacent the outer surface of the container 12. The second end 52a of the circumferential part 52 is inserted between the second part of the locking flange 26 and the outer surface of the container 12 with the rib 70 on the outer surface of the circumferential part 52 engages lip 32 on the inner surface of the second part of the locking flange 26. This configuration enables an increased interior of the container 12 to increase the side and amount of objects held therein and maintains a secure fit of the lid 14. However, since a portion of the circumferential part 52 of the circumferential part is spaced from the locking part, the lid 14 is easy to remove with fingers or other objects.

In the second orientation, the inner surface of the circumferential part 52 of the circumferential portion 36 is disposed adjacent the outer surface of the container 12. The first end 52a of the circumferential part 52 is inserted between the second part of the locking flange 26 and the outer surface of the container 12 with the rib 72 on the outer surface of the circumferential part 52 engages the lip 32 on the inner surface of the second part of the locking flange 26. This configuration enables recess to be disposed on the top of the container 12. In this configuration, the user can feed or provide water (liquid) for a pet or use the container 12 to hold objects while allowing them to be easily accessible without removing the lid 14. Moreover, similar to the first configuration, the second configuration enables a secure fit of the lid 14. However, since a portion of the circumferential part 52 is spaced form the locking part, the lid 14 is easy to remove with fingers or other objects.

Furthermore, to remove the lid 14, in one embodiment the circumferential part 52 can flex inwardly toward the outer surface of the container 12. As can be understood, in both the first and second orientations, the respective rib 70, 72 can be disengaged in this regard and the lid 14 can be easily removed from the container 12.

The lid 14 can be removed from the container 12 and the container 12 can be cleaned or washed out easily. Since the container 12 is plastic and has holes 24 in the bottom 16 of the container 12, the container 12 can be washed with a hose or other water dispending device and the water will easily and quickly drain from the interior portion I of the container 12.

The container 12 and lid 14 can be any size and shape suitable and any description in this manner is merely exemplary and not meant to limit the specific configuration of the container system 10.

### General Interpretation of Terms

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” or “element” when used in the singular can have the dual meaning of a single part or a plurality of parts. Also, as used herein to describe the above embodiment(s), the following directional terms refer to those directions of a reversible lid. Accordingly, these terms as utilized to describe the present invention should be interpreted relative to a reversible lid.

The terms of degree such as “generally” and “approximately” as used herein mean a reasonable amount of deviation of the modified term such that the end result is not significantly changed.

While only selected embodiments have been chosen to illustrate the present invention, it will be apparent to those skilled in the art from this disclosure that various changes and modifications can be made herein without departing from the scope of the invention as defined in the appended claims. For example, the size, shape, location or orientation of the various components can be changed as needed and/or desired. Components that are shown directly connected or contacting each other can have intermediate structures disposed between them. The functions of one element can be performed by two, and vice versa. The structures and functions of one embodiment can be adopted in another embodiment. It is not necessary for all advantages to be present in a particular embodiment at the same time. Every feature which is unique from the prior art, alone or in combination with other features, also should be considered a separate description of further inventions by the applicant, including the structural and/or functional concepts embodied by such feature(s). Thus, the foregoing descriptions of the embodiments according to the present invention are provided for illustration only, and not for the purpose of limiting the invention as defined by the appended claims and their equivalents.

What is claimed is:

1. A reversible lid, the reversible lid comprising;
a covering portion configured to cover an opening in a container, the covering portion being circular and having a periphery; and
a circumferential portion having a first part, a second part and a transverse part, the first part having a first end and the second part having a second end, and extending generally perpendicular from the periphery of the covering portion at the first end, the transverse part extending radially outwardly transverse from the second end of the first part, and the second part extending in a same direction as the first part and connected to the transverse part,
the first part, the second part and traverse part configured such that in a first orientation the lid is configured to cover the container with a first side of the transverse part abutting a rim of the container and in a second orientation the lid is configured to cover the container with the second side of the transverse part abutting the rim of the container.

2. The reversible lid according to claim 1, wherein
in the first orientation, an inner surface of the second part is configured to be adjacent an outer surface of the container.

3. The reversible lid according to claim 2, wherein
in the second orientation, an inner surface of the first part is configured to be adjacent the outer surface of the container.

4. The reversible lid according to claim 1, wherein
in the second orientation, an inner surface of the first part is configured to be adjacent an outer surface of the container.

5. The reversible lid according to claim 1, wherein
the circumferential portion includes a first circumferential area and a second circumferential area, in the first circumferential area, a distance from the first end to the transverse part is greater than a distance from the second end to the traverse part.

6. The reversible lid according to claim 5, wherein
in the second circumferential area, the distance from the first end to the transverse part is less than the distance from the second end to the traverse part.

7. The reversible lid according to claim 1, wherein
in the first orientation, the covering portion is configured to be longitudinally above the rim of the container.

8. The reversible lid according to claim 1, wherein
in the second orientation, the covering portion is configured to be longitudinally below the rim of the container.

9. The reversible lid according to claim 1, wherein
in the second orientation, the lid is configured to form a recess.

10. A container system, comprising:
a container having an opening and a rim; and
a lid including a covering portion and a circumferential portion, the covering portion covering the opening in the container, being circular and having a periphery, and the circumferential portion having a first part, a second part and a transverse part, the first part having a first end and the second part having a second end, and extending generally perpendicular from the periphery of the covering portion at the first end, the transverse part extending radially outwardly transverse from the second end of the first part, and the second part extending in a same direction as the first part and connected to the transverse part, the first part, the second part and traverse part configured such that when disposed on the container in a first orientation, the lid covers the container with a first side of the transverse part abutting the rim of the container and in a second orientation the lid covers the container with the second side of the transverse part abutting the rim of the container.

11. The container system according to claim 10, wherein
in the first orientation, an inner surface of the second part is configured to be adjacent an outer surface of the container.

12. The container system according to claim 11, wherein
in the first orientation, an inner surface of the second part is configured to be adjacent the outer surface of the container.

13. The container system according to claim 10, wherein
in the first orientation, an inner surface of the second part is configured to be adjacent an outer surface of the container.

14. The container system according to claim 10, wherein
the circumferential portion includes a first circumferential area and a second circumferential area, in the first circumferential area, a distance from the first end to the transverse part is greater than a distance from the second end to the traverse part.

15. The container system according to claim 14, wherein
in the second circumferential area, the distance from the first end to the transverse part is less than the distance from the second end to the traverse part.

16. The container system according to claim 10, wherein
in the first orientation, the covering portion is longitudinally above the rim of the container.

17. The container system according to claim 10, wherein
in the second orientation, the covering portion is longitudinally below the rim of the container.

18. The container system according to claim 10, wherein
in the second orientation, the lid forms a recess.
